(19) United States
(12) Patent Application Publication
(10) Pub. No.: US 2018/0257780 A1
(43) Pub. Date: Sep. 13, 2018

(54) KINETIC UNMANNED AERIAL VEHICLE FLIGHT DISRUPTION AND DISABLING DEVICE, SYSTEM AND ASSOCIATED METHODS

(71) Applicant: Jeffrey Sassinsky, Haddonfield, NJ (US)

(72) Inventor: Jeffrey Sassinsky, Haddonfield, NJ (US)

(21) Appl. No.: 15/454,359

(22) Filed: Mar. 9, 2017

(51) Int. Cl. B64D 5/00; B64C 39/02; G08G 5/00; B64D 47/08; B64D 7/00; F41H 13/00; F41B 13/10; F41H 9/00; F41H 11/02

(52) U.S. Cl. CPC B64D 5/00; B64C 39/024; G08G 5/0069; B64D 47/08; B64D 7/00; B64C 2201/182; F41B 13/10; F41H 13/0012; F41H 9/00; F41H 13/0062; F41H 11/02; F41H 13/00

(57) ABSTRACT

The present invention is a device, system(s) and/or method(s) for disrupting, capturing, and/or disabling and unmanned aerial vehicle(s) in flight, on the ground, or preparing for flight that may or may not be under the control of the invention operator. In certain embodiments, the invention is supported and carried by an unmanned aerial vehicle that is controlled by a ground operator, a computer process and associate hardware, or any combination thereof. In other embodiments, the invention contains physical destruction devices such as projectiles, explosives, spikes, electric shock generators, etc. The invention is manipulated to track, intercept, capture, disrupt, disable and/or move a target unmanned aerial vehicle. In certain embodiments, the invention includes materials able to contain, at least in part, hazardous materials and/or conditions caused by the target unmanned aerial vehicle. In certain embodiments, the invention interfaces with external unmanned aerial vehicle detection/tracking systems. A unique design element in certain embodiments is the ability to limit the potential of the captured aerial vehicle escaping the device and/or falling to the ground. Another unique design element in certain embodiments is the ability of the invention to limit collateral damage caused by the captured unmanned aerial vehicle or apparatuses contained thereon. Another unique design element is the ability of the invention to interface with external unmanned aerial vehicle detection/tracking systems.

### CROSS REFERENCE

This patent application claims the benefit of provisional patent application 62/305,570, titled Kinetic Unmanned Aerial Vehicle Flight Disruption and Disabling Device, System, and Associated Methods, which is hereby incorporated by reference in its entirety.

### FIELD OF THE INVENTION

The present invention relates generally to aviation and, more specifically, to the field of unmanned aerial vehicles, and capturing, disruption, disabling, and/or physically moving unmanned aerial vehicles, and, more specifically, performing said acts on unwanted or potentially dangerous unmanned aerial vehicles.

### BACKGROUND OF THE INVENTION

It would be advantageous to have a device and/or system and/or method for capturing, disrupting and/or disabling unmanned aerial vehicles during flight. More specifically, it would be desirable to capture, disrupt and/or disable unmanned aerial vehicles that are not under the control of the operator, are under the control of another operator, are on an autonomous flight plan or are under the control of an onboard or remote computing device. Such a device, system and/or method would be useful for several purposes, including but not limited to, providing a defense against undesired, illegal or potentially dangerous unmanned aerial vehicles, capturing and/or disabling malfunctioning unmanned aerial vehicles, or as a sport/game in which participants are tasked with capturing and/or disabling other unmanned aerial vehicles. Additionally, in certain instances, it would be desirable to capture and/or disable unmanned aerial vehicles during flight in such a manner that disabled vehicles can no longer sustain flight. Furthermore, in certain instances, it would be desirable to capture and/or disable unmanned aerial vehicles in such a manner that attempts to prevent the vehicle from falling to the ground during or following capture and/or disabling. Among other advantages, this would limit potential damage to the captured unmanned aerial vehicle, would limit potential damage to property on the ground, would limit potential injuries to persons on the ground and would reduce the possibility of unintentionally dispersing, detonating or discharging harmful substances, explosives or weapons on the captured unmanned aerial vehicle. Furthermore, in certain instances, it would be advantageous to be able to physically move or relocate captured unmanned aerial vehicles to a location of choice while limiting potential danger to persons, property and/or objects in the vicinity.

Physically moving captured unmanned aerial vehicles to a location of choice would be beneficial in several cases, including but not limited to, moving the captured vehicle to a secure area when the vehicle may potentially contain harmful substances and/or dangerous devices. Furthermore, in certain instances, it would be advantageous to be able to capture, disrupt and/or disable multiple unmanned aerial vehicles in a single sortie. Capturing and/or disabling multiple unmanned aerial vehicles would be beneficial when attempting to mitigate harmful or undesired effects from a swarm of unmanned aerial vehicles. A swarm of unmanned aerial vehicles, for the purposes of this document, is defined as two or more unmanned aerial vehicles operating concurrently, whether independently or in concert with each other. Furthermore, in certain instances, it would be advantages to mitigate collateral damage should a captured or disabled unmanned aerial vehicle cause a harmful condition, such as but not limited to, detonating, catching fire, dispersing a harmful substance or discharging a firearm or weapon.

Furthermore, in certain instances, it would be advantages to limit items from falling or being released from a captured or disabled unmanned aerial vehicle, such as, but not limited to, contraband, explosive devices, harmful substances, memory devices storing data, drugs, illicit or illegal materials, and/or weapons. Furthermore, in certain instances, it would be advantageous for the disruption device to interface with external unmanned aerial vehicle detection and tracking systems to receive information regarding potential and identified targets. This interface system would permit the disruption device described herein to perform more accurate, farther and potentially faster interception and disruption of unmanned aerial vehicles both close to the disruption device departure point and beyond visual line of sight (“BVLOS”) of the operator or base station. Furthermore, in certain instances, it would be advantageous for the interface system with external unmanned aerial vehicle detection and tracking systems to follow a standard set of instructions (the “protocol”) such that any detection and tracking system meeting the defined parameters, whether the detection system is created by the inventor or any 3^{rd} party, could effectively interface with the invention provided it follows the protocol.

### SUMMARY OF THE INVENTION

The invention fulfills the needs and deficiencies heretofore described by providing a device, system(s) and/or method(s) for disrupting, capturing, and/or disabling unmanned aerial vehicles in flight that may or may not be under the control of the invention operator. In certain embodiments, the invention performs the disruption in such a manner that the potential for collateral damage from the captured unmanned aerial vehicle is minimized, the potential for the captured unmanned aerial vehicle, and/or any apparatuses contained thereon, falling from the disruption device is minimized. In certain embodiments, accurate and timely unmanned aerial vehicle capture can be aided by an interface data connection to external unmanned aerial vehicle detection and tracking systems.

A general background on unmanned aerial vehicles and reasons that it would be desirable to disrupt their flight and/or disable them is helpful to better understand the invention. The proliferation and use of unmanned aerial vehicles (“UAVs”) has exploded in recent years. UAVs can be relatively easy to fly, may operate autonomously, are readily available and can be used by most any person. Their uses and areas of operation include many purposes, which are ever expanding, such as aerial photography, hobby flying, agriculture monitoring, pesticide and fertilizer delivery, construction progress monitoring, public safety, land surveying, etc. Many UAVs are capable of carrying a payload, whether or not they are designed to do so, and can send live video and/or data back to an operator. UAVs may also operate in concert with each other through direct UAV-to-UAV interaction, interaction with a remote control, and/or interaction with a remote monitoring and command device. Such multi-UAV operations are commonly referred to a “swarm”. A swarm is defined herein for the purposes of this document as two or more UAVs operating concurrently.

Although there are many beneficial, entertaining and innocuous uses for unmanned aerial vehicles, with their proliferation also comes certain risks to individuals, infrastructure, security and the public at large. Rogue or undesired UAVs may be used to perform illicit, dangerous or undesired activities and tasks such as, but not limited to, obtaining surveillance of sensitive areas (e.g. monitoring a secure nuclear power plant, surveilling troop movements, etc.), carrying illegal items (e.g. delivering drugs or weapons to a prison, transporting illegal drugs across borders, etc.), discharging weapons, carrying explosives, or spreading harmful substances with the intent to terrorize, maim or kill.

UAVs can take many forms. For illustrative purposes, they can be, but are not limited to: vertical takeoff and landing, such as traditional single rotor or multi-rotor designs, which operate much like a helicopter with a rotor(s) or propellers lifting the aircraft into the air; fixed-winged designs which operate much like an airplane using wings with a propulsion device like a propeller; or hybrid-designs that can transform from a helicopter or multi-rotor like design that can take off and land vertically, to a fixed-winged like design that can fly forward using wings to create some or all the lift required to remain aloft. Balloons, blimps, parachutes, gliders, traditional helicopters, etc., could also be utilized as the basis for unmanned aerial vehicles. Additionally, many future designs and permutations are likely, currently unknown or not yet invented.

Unmanned aerial vehicles can be operated by a remote pilot using control signals sent via radio waves, light, tethers, etc., or using methods currently unknown or not yet invented. They can also operate autonomously using onboard computers to calculate an optimal or desired flight path, follow a preprogrammed flight path, or follow a flight path uploaded to the aircraft while it is in flight. Other methods and systems to control unmanned aerial vehicles are likely to be invented or are currently unknown.

Both kinetic and non-kinetic methods may be used to disrupt or disable unmanned aerial vehicles. The invention utilizes a kinetic method of disrupting or disabling an unmanned aerial vehicle.

Non-kinetic methods typically utilize the broadcasting of radio waves to jam, spoof, overpower, imitate or take control of the control or navigation signals utilized by the target unmanned aerial vehicle. Many non-kinetic methods may have limited effectiveness and may even be hazardous to use given the multitude of vehicle types and control methods, the haphazard nature of broadcasting a “jamming” signal as well as the unintended or undesirable effect of collecting, analyzing and/or storing irrelevant data from non-UAV sources. The following examples are presented for consideration.

Non-kinetic methods intended to electronically jam the UAV's control signals may be useless against an aircraft that is operating autonomously. Non-kinetic methods intended to take control of the control signal may be useless against an aircraft that is using security and encryption to protect the control signal. Non-kinetic methods intended to receive, analyze, modify and transmit (hereafter referred to as “spoofing”) may require the reception, analysis and/or viewing of other data sources and traffic irrelevant to the target UAV, such as but not limited to, wireless networks (“Wi-Fi”), first responder and security sources, corporate and private data, etc. Non-kinetic methods intended to jam navigation signals, such as GPS or GLONASS, may not affect an aircraft under positive control from the ground. The aircraft may also use alternative methods for navigation that are not susceptible to jamming, such as, but not limited to, inertial navigation systems (“INS”). Furthermore, GPS and/or GLONASS jamming signals may also affect other devices or vehicles in the area, such as, for illustrative purposes but not intended to be an exhaustive list, navigation equipment in manned aircraft, ground vehicles, or emergency vehicles and equipment. Additionally, the legality of broadcasting a jamming signal or receiving and analyzing transmitted data is under dispute in the United States and many other countries around the World at the time of this submission.

The invention is not affected by the above limitations thereby demonstrating some of its advantages, its unique capabilities and how it helps alleviate these deficiencies. Unmanned aerial vehicle programming, electronic variations and autonomous or manual usage mode will have no effect, or little effect, on the usefulness of the invention because it physically captures, disrupts and/or disables the target UAV in certain instances in a manner that, due to aspects of its unique design, limits potential collateral damage. This is often an essential quality due to the important nature of many of the invention's intended uses.

The invention helps alleviate these deficiencies by providing a system, methods and device (the “disruption device”) that incorporates several unique components including, in some embodiments, but not limited to: a specially and uniquely designed disruption device that may use, but is not limited to, a net like design of specifically calculated and deliberate characteristics that promote the entanglement of unmanned aerial vehicles in such a manner that they cannot free themselves; materials that resist damage and/or breakage possibly from the impact with unmanned aerial vehicles or their propulsion methods (i.e. propellers); a structure that shapes the capture material in a specific manner as to promote the correct alignment of the disruption device in relation to the target UAV; a shape and design that limits captured unmanned aerial vehicles or apparatuses contained thereon from falling to the ground during or after capture; a method of supporting the device and transferring loads from captured unmanned aerial vehicles through the device and capture material to the carrying structure or vehicle; a method for attaching the device to a carrying structure or vehicle which may be, but is not limited to, a fixed structure, a manned aerial vehicle or an unmanned aerial vehicle; a shape and design that permits multiple unmanned aerial vehicles to be disrupted in a single flight (“sortie”); a lining attached to or comprising the capture area that resists and/or contains, at least in partial, hazardous conditions, such as for illustrative purposes but not intended to be a limitation, explosions, fires, projectiles and/or harmful substances; and a system and methodology for interacting with and transferring data between the invention and external UAV detection and tracking systems. The carrying device is intended to, in some embodiments but not in all, move and/or position the disruption device in such a manner as to intercept and capture the target UAV while minimizing potential collateral damage.

Furthermore, in some embodiments, the disruption device will forego capture and instead inflict enough damage to the target UAV such as to disable it from remaining aloft. For illustrative purposes, but not intending to be a limitation, this may be used when capture attempts are unsuccessful, when operating in a remote location where potential collateral damage is unimportant, or when used as a last line of defense. In this embodiment, the disruption device will take such actions as to inflict significant damage to the target UAV by colliding with it or utilizing an alternative disruption technique. The alternative disruption techniques can vary, whether used with a capture mechanism or not. For illustrative purposes, but not intending to be a limitation, the disruption technique may include other devices and structures attached to the disruption device such as a net launcher, gun, canon, explosive, battering ram, spike, electric shock generator, chemical sprayer, etc.

Furthermore, in some embodiments but not all, the device may include a method to positively disable captured unmanned aerial vehicles which may include, but is not limited to, entanglement, imparting physical damage, overriding or blocking the control signal, overriding or blocking navigation signals (e.g. GPS and/or GLONASS), creating a magnetic field around the vehicle, covering the vehicle in a substance that inhibits its operation, and/or delivering an electric shock to the vehicle. In addition, the device may be part of a larger system that may or may not include an unmanned aerial vehicle and associated systems and devices such as cameras, sensors, autopilots, automated flight systems, remote deployment devices and methods that are used to carry the disruption device, intercept and ultimately disrupt and/or disable unmanned aerial vehicles in flight.

One unique aspect of the disruption device in its capture configuration is its shape. The invention's shape and structure significantly reduces a captured UAV's ability to escape the disruption device or fall to the ground once it is disabled. This protects persons, property and objects in the vicinity and on the ground and increases the ability of the system to physically move the target UAV to another, potentially safer or more desirable, location. It also limits damage to the target UAV following its capture and/or disabling caused by a fall to the ground. This is especially important if the target UAV is carrying an explosive or dangerous material or if the target UAV is to be returned to flight.

Another unique aspect of the invention is, in certain embodiments but not all, its deployment method. The disruption device may be rolled up or compacted and deployed remotely using a system of winches, latches and/or motors while the device is in flight. This allows for added maneuverability and speed while intercepting a target UAV and provides a significant disruption area once near the target UAV. In certain embodiments, but not all, the disruption device may be fired at the target UAV from a launcher, for example but not intended to be a limitation, an air cannon attached to the carrying device.

Another unique aspect of the invention is, in certain embodiments but not in all, its targeting system. The invention includes a camera(s) and/or a sensor(s), such as but not limited to, video, infra-red, LiDAR, SONAR, RADAR, etc. These sensors detect a target UAV in the vicinity which allows a computer to command the disruption device such that the disruption device pursues the target UAV. In certain embodiments, but not all, one or more sensors are positioned in the capture area of the device. This allows an operator to more easily maneuver the disruption device to a target UAV by reducing or eliminating offset or parallax in an image or video stream from the system. In certain embodiments, but not all, other cameras and sensors are positioned in secondary locations to monitor, detect, calculate distance, aid in capture, detect a successful capture, provide a live picture or video of the surrounding area, disruption device, captured UAV and associated conditions, etc., to the operator, onboard and/or remote computer program(s) and associated systems and devices.

In some embodiments but not in all, the system may be controlled by an operator, an automated computer program and associated systems and devices, or a combination of both. Regardless of the control method, the disruption device can be moved or positioned to positively intercept, disrupt and/or disable the target UAV whether close to, or in some instances but not intended to be a limitation, at significant distance from the operator, base station and/or departure point. The control method, whether autonomous, manual or a combination thereof, provides for unique and useful aspects of the invention and are included, but not limited to, the description contained herein.

In some embodiments but not in all, the unique design of the disruption device permits the capture, disruption or disabling of multiple target UAVs in a single flight or sortie. This allows the invention to effectively mitigate potential dangers and undesired effects from a swarm of target UAVs.

In some embodiments but not in all, the system interfaces with external UAV detection and tracking systems. This allows the invention to intercept and capture target UAVs that are identified and communicated to the invention by the external detection and/or tracking system(s) via a unique data interface (a “protocol”) and associated equipment thereby aiding, but not limited to, extended range, interoperability with tracking and detection systems already in place or to be put in place, improved accuracy, and the installation of detection and tracking solution as appropriate to the geography and unique conditions of the intended operational area. The data interface, protocol and associated equipment also expands the usability of the invention by providing for methods to interact with 3^{rd}-party detection and tracking systems whether said systems are designed by the inventor or other entities.

Among other things, it is the object of the present invention to provide a system, device(s) and/or method(s) for capturing, disrupting and/or disabling an aerial vehicle, in many cases, an unmanned aerial vehicle, while that target vehicle is in flight, on the ground or preparing for flight, such that the target UAV is disrupted in an expeditious manner, in some cases with limited collateral damage to person, property and structures in the vicinity and, in some cases, aided by external UAV detection and tracking systems.

### BRIEF DESCRIPTION OF THE FIGURES

FIG. 1 is an isometric perspective view according to an embodiment of the present invention.

FIG. 2 is a front perspective view according to an embodiment of the present invention depicting the invention attached to a support vehicle for illustrative purposes only and not intended to be a limitation of any kind.

FIG. 3 is a front perspective view according to an embodiment of the present invention depicting the placement of a targeting camera for illustrative purposes only and not intended to be a limitation of any kind.

FIG. 4 is an isometric perspective view according to an embodiment of the present invention depicting a capture net launching solution for illustrative purposes only and not intended to be a limitation of any kind.

FIG. 4 is an isometric perspective view according to an embodiment of the present invention depicting a collateral damage limiting liner or capture area for illustrative purposes only and not intended to be a limitation of any kind.

FIG. 5 is a flow chart depicting an implementation of the external UAV detection and tracking system interface methodology, system and associated equipment according to an embodiment of the present invention for illustrative purposes only and not intended to be a limitation of any kind.

### REFERENCE NUMERALS IN THE DRAWINGS

1—Harness

2—Upper support

3—Rear capture area

4—Side containment area

5—Lower support

6—Lower containment area

7—Lower attach point

8—Flight path

9—Upper attach point

10—Support vehicle

11—Harness attach point

12—Extension

13—Targeting camera

14—Front containment area

15—External detection/tracking system.

16—Tracking packet.

17—Ready for command?

18—Error packet.

19—Automatic mode?

20—Operator approves command?

21—Transmit command.

22—Disruption device execution?

23—Perform command.

24—Monitor command result.

25—Update status.

26—Status packet.

27—System status.

28—Status display.

### DETAILED DESCRIPTION OF THE INVENTION

The invention is directed to a device, system and associated methods to disrupt, capture and/or disable aerial vehicles, more specifically unmanned aerial vehicles, while those vehicles are in flight, on the ground or preparing for flight. The device, system and associated methods according to the present invention are specifically and uniquely designed to intercept a target unmanned aerial vehicle, or target unmanned vehicles in the case of a swarm, while that target vehicle(s) is in flight, on the ground or preparing for flight. In certain embodiments, the invention is intended to ensnare, capture, disrupt and/or disable the target vehicle in such a manner as to limit potential collateral damage caused by the disrupted UAV. In certain embodiments the invention is to be aided by interfacing with external UAV detection and tracking systems. And, in certain embodiments and some instances, to move a captured target vehicle(s) to a predetermined location, calculated location, or a location of the operator's choosing. When referring to the figures, numerals indicate like or corresponding parts throughout the views.

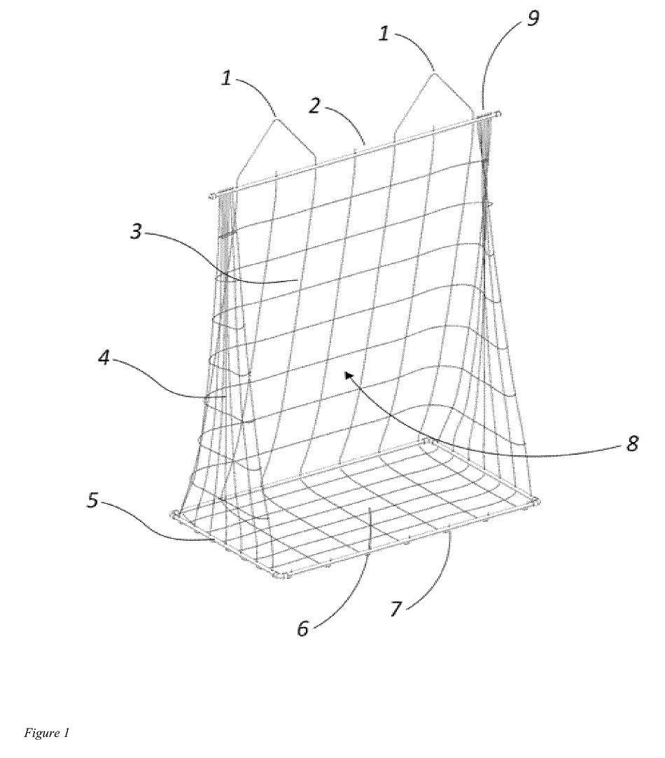

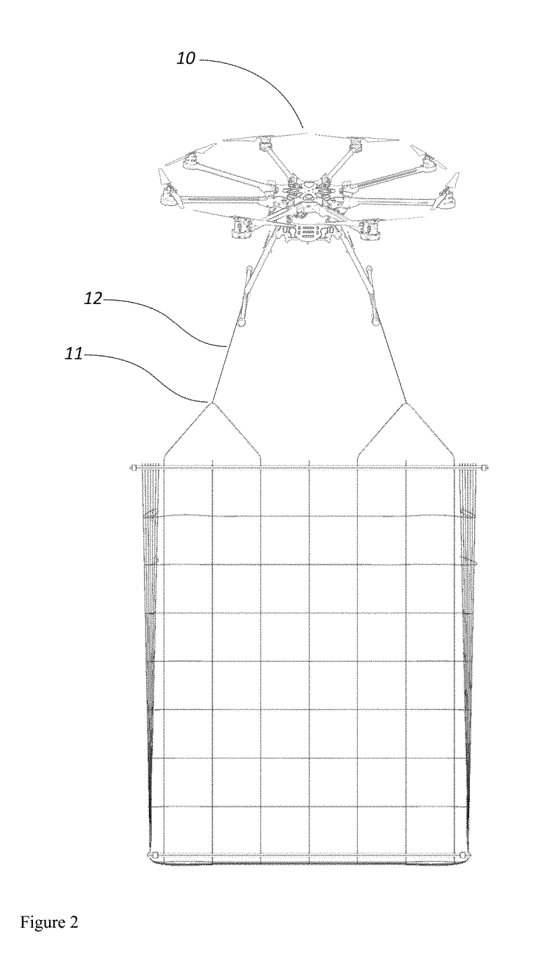

Referring to FIG. 1, the invention, in some embodiments but not all, is designed to be hung from a support vehicle or structure. The support vehicle may be, but is not limited to, a manned or unmanned vehicle. For purposes of illustration, and not in any way intended to be limiting, the following description will make reference to an unmanned aerial vehicle support vehicle, referring to FIG. 2, support vehicle 10.

Referring to FIG. 1 and FIG. 2, the harness 1 can attach to support vehicles or structures of varying configurations. The upper portion of the harness 1 can, in some embodiments but not all, be fitted with extensions 12 at the harness attach point 11, such as, but not limited to, chains, wires, bolts, etc., that attach to the support vehicle 10. The harness 1 transfers the weight of the disruption device and any load contained therein from the upper support 2 to the extensions 11 and/or the support vehicle 10 directly. The harness 1 is also designed in such a manner to distribute the load across the upper support 2. By spreading the attach points of harness 1 across the upper support 2, the support vehicle 10 is able to exert more positive control over the yaw axis of the disruption device and better stabilize the disruption device in flight. This is as opposed to an attachment harness or method that utilizes an alternate configuration with the harness attaching at a single central point on the upper support 2 or at centrally located points.

The harness 1 is made from, but not limited to, rope, chain, wire, pipe, etc. Other embodiments may use other materials as desired. The harness 1 is attached to the upper support using, but not limited to, knots, washers, bolts, pull ties, twist ties, wire, restraints, etc. The attachment is performed such that the load from the upper support 2 is able to be transferred into the harness 1 and ultimately into the support vehicle 10.

The upper support 2 transfers the load from the capture material, surfaces, support structure and any items contained therein into the harness. The upper support 2 also helps maintain the unique shape and configuration of the invention. It is the central attachment point for the rear capture area 3 and side containment areas 4. In some embodiments, but not intended to be a limitation, the upper support 2 may contain holes to allow the harness 1, the material of the rear capture area 3 and the material of the side containment areas 4 to pass through and be secured to the upper support 2. The material of the rear capture area 3 and the side containment areas 4 may be, but are not limited to, rope, chain, wire, pipe, etc., and are secured to the upper support 2 at upper attach points 9 using, but not limited to, knots, washers, bolts, pull ties, twist ties, wire, restraints, etc. In some embodiments, but not intended to be a limitation, the upper support 2 may be made of plastic pipe, wood, metal rod, fiberglass, carbon fiber, etc. It is made using a strong yet light material in order to properly transfer the load, resist breaking and fatigue and help keep the overall weight of the device to a minimum. In some embodiments, but not intended to be a limitation, the rear capture area 3 and side containment areas 4 may be directly attached to the support vehicle 10 so as to eliminate the upper support 2. In some embodiments, these attach points are distributed across the support vehicle 10, such as across the vehicle's arms or structure, to provide enhanced yaw control over the disruption device similar to that achieved with upper support 2 and harness 1.

The upper support 2 attaches to, among others, the rear capture area 3 and the side containment areas 4. The rear capture area 3, side containment areas 4 and lower containment area 6 are made in some embodiments, but not intended to be a limitation, out of rope, wire, chain, straps, etc. The areas are comprised of vertical and horizontal components that are arranged in a fashion that, for illustration but not intended as a limitation, resembles a net. The horizontal and vertical components of the rear capture area 3, the side containment areas 4 and the lower containment area 6 are secured to each other in some embodiments, but not intended as a limitation, using knots, wire ties, wound wire, pull ties, fasteners, twist ties, sewn areas, glue, string, etc.

As described, the rear capture area 3 has horizontal and vertical components fashioned, for illustrative purposes but not intended as a limitation, like a net. The distance between the horizontal components and the distance between the vertical components varies among embodiments and is designed using differing measurements in order to promote the entanglement of target UAVs of varying sizes and configurations. As an example, but not intended as a limitation, a horizontal and vertical distance of 9-inches may be used in some embodiments because this size may promote the entanglement of light to medium sized target UAVs without allowing the target UAV to pass though the capture area. Other embodiments may use larger or smaller distances between horizontal components and vertical components in order to promote the entanglement of larger or smaller target UAVs.

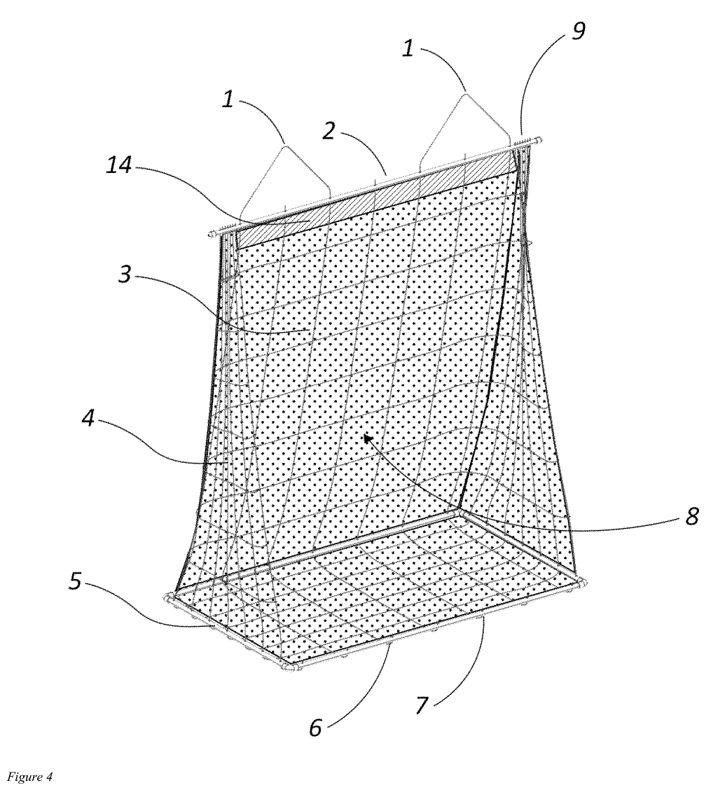

In some embodiments, rear capture area 3, side containment areas 4 and lower containment area 6 are lined with or made from materials intended to contain hazardous conditions, for example but not intending to be a limitation, blast resistant, projectile resistant, fire resistant and/or chemical resistant fabric or materials as illustrated in FIG. 4. In some embodiments, a front containment area 14 made from such material is fitted to enclose the front of the device depicted by flight path 8 when deployed. The front containment area 14 is in a retracted condition prior to capture to allow the target UAV to enter the device through flight path 8 and then the front containment area 14 is remotely or automatically deployed to fully enclose the captured UAV in the disruption device. This will assist in containing hazardous conditions caused by the UAV, for illustrative purposes but not intending to be a limitation, an explosive, projectile, and/or chemical or biological agent, thereby further reducing the possibility of collateral damage. In some embodiments, but not intending to be a limitation, the front containment area 14 is rolled above the area depicted by flight path 8. An electronic or mechanical latch releases the front containment area 14 which unrolls down a set of guides affixed to the disruption device. In other embodiments, but not intending to be a limitation, the front containment area 14 is deployed using a cable or other mechanism that extends and retracts the material in an accordion fashion across the area depicted by flight path 8.

Another unique aspect of the invention includes the side containment areas 4 and lower containment area 6. As previously described, it is advantageous to capture a target UAV without allowing it to escape the disruption device or drop to the ground. Having only the rear containment area 3 may allow a disabled or disrupted target UAV to escape the invention. It may also allow a disabled or disrupted target UAV to fall to the ground if the UAV is not fully entangled in the rear capture area 3. The side containment areas 4 provide additional capture or containment material thereby increasing the likelihood of positively capturing and containing a target UAV. The lower containment area 6 provides additional capture or containment material thereby reducing the likelihood that a captured UAV would fall to the ground once disabled or disrupted. This helps protect persons and property in the vicinity of and below the invention and improves the ability of the invention to move the captured target UAV to a location of the operator's choice. It also limits the potential damage that a target UAV containing or carrying illicit or dangerous devices or substances could inflict.

Like the rear capture area 3, in some embodiments, the side containment areas 4 and lower containment area 6 are made from horizontal and vertical components fashioned, for illustrative purposes but not intended as a limitation, like a net. The distance between the horizontal components and the distance between the vertical components varies among embodiments and is designed using differing measurements in order to promote the containment of target UAVs of varying sizes and configurations. These measurements may vary from the measurements of other components of the invention, including the rear capture area 3, and from each other. In other embodiments, the side containment areas 4 and lover containment area 6 are lined with or made from materials intended to contain hazardous conditions, for example but not intending to be a limitation, blast resistant, projectile resistant, fire resistant and/or chemical resistant fabric or materials as illustrated in FIG. 4.

For illustrative purposes, but not intended to be a limitation, the lower containment area 6 may use smaller distances between the horizontal and vertical components as that used for the rear capture area 3. This is because the rear capture area 3 would be the most likely area to encounter a flying target UAV and is intended to entangle it. The lower containment area 6 would be most likely area to encounter a disabled, or partially disabled, target UAV that is no longer flying normally and is falling toward the ground. Smaller distances between the horizontal and vertical components of the lower containment area 6 would be more likely to support the falling device and not allow it to pass through the open areas. In this embodiment, the lower containment area 6 is more likely to support it and prevent it from falling to the ground. Likewise, the side containment areas 4 may also use differing measurements for the horizontal and vertical components commiserate with its intended purpose, in this embodiment, of acting as additional containment areas for the target UAV but not as the primary and most likely initial capture area.

The rear capture area 3, side containment areas 4 and lower containment area 6 components in some embodiments but not intended as a limitation, pass though or are fastened to the lower support 5. The lower support 5 helps maintain the unique shape and size of the invention. In some embodiments, holes are drilled in the lower support 5 to allow the components of the rear capture area 3, side containment areas 4 and lower containment area 6 to pass through the lower support 5 and to attach to each other. In other embodiments, attachment hardware is attached to lower support 5 to join rear capture area 3, side containment areas 4 and lower containment area 6. In some embodiments, but not intended to be a limitation, the lower support 5 may be made of plastic pipe, wood, metal, fiberglass, carbon fiber, etc. It is made using a strong yet light material in order to properly transfer the load, resist breaking and fatigue and help keep the overall weight of the device to a minimum.

The front of the invention is open to allow a target UAV to enter the device as illustrated by flight path 8. For illustrative purposes, but not intended as a limitation, the invention may be positioned in front of a moving target UAV, may be moved to a stationary (i.e. “hovering”) target UAV or may intercept a target UAV in which case both the invention and the target UAV are in motion. The lower containment area 6 is attached to the lower support 5 at lower attach points 7 in order to allow the front of the invention to be open. The lower containment area 6 components are attached at the lower attach points 7 in some embodiments, but not intended as a limitation, using knots, washers, bolts, pull ties, twist ties, wire, restraints, etc. In some embodiments, a front containment area 14 may be deployed to enclose the front of the device as illustrated by flight path 8 once the target UAV(s) is captured.

Loads from a captured or disabled target UAV(s), and from the various parts of the invention are transferred between the components through the lower support 5. The weight and configuration of the lower support 5 also helps promote the proper orientation of the invention while it is use. It helps stabilize the invention while in motion and in flight, keeps the device below the support vehicle 10 and maintains the size and shape of the invention, especially when it is supporting a captured or disabled target UAV.

In some embodiments, but not intended as a limitation, disruption and or disabling devices are directly attached to support vehicle 10. This may be in conjunction with or in lieu of the capture areas. Such devices may include, but are not limited to, projectiles, explosives, battering rams, reinforced areas, chemical sprayers, spikes, electric shock generators, etc. In other instances, support vehicle 10 is used to directly impact with the target UAV in order to disabled it. The disruption devices may be controlled by an onboard computer, targeting computer, remote computers and/or the operator. These methods of disruption can be used with collateral damage is unimportant, such as but not limited to, when used in a remote location, when used to protect a high value target, when capture fails or when used as a last line of defense.

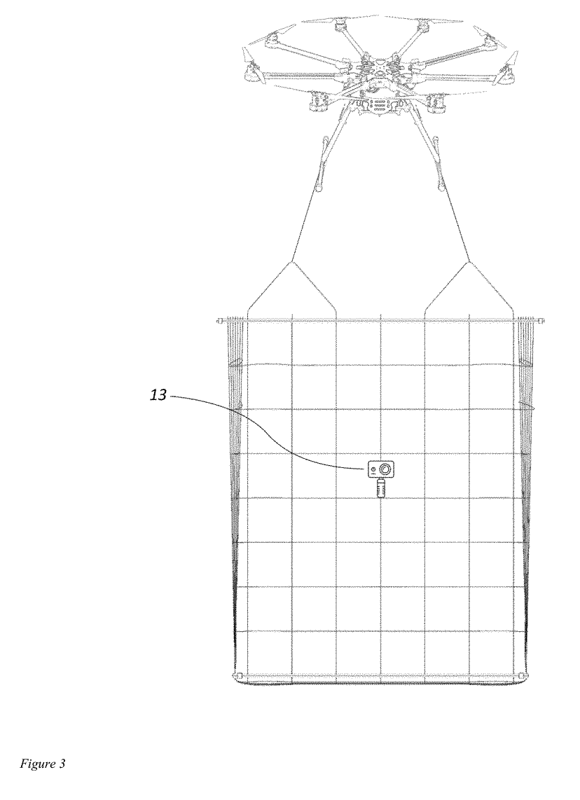

Referring to FIG. 3, another unique aspect of the invention, in some embodiments but not intended to be a limitation, is that it is equipped with a targeting camera(s) and/or sensor(s) 13. A targeting camera(s) and/or sensor(s) provides a significant and unique advantage of providing the operator of the device, targeting program and associated equipment and/or automatic flight control system with a more natural and useful view of the area surrounding the invention, including but not limited to, a target aircraft. The targeting camera and/or sensor is located in the rear capture area 3. This eliminates parallax from the image when capturing a target UAV as opposed to utilizing a camera and/or sensor mounted elsewhere on the invention or on the support vehicle 10. This simplifies target and capture calculations and adjustments required when the targeting camera and/or sensor is remotely located thereby increasing accuracy.

In some embodiments but not intended to be a limitation, the targeting camera 13 sends a live wireless video feed to a receiver(s). For illustrative purposes, but not intended to be a limitation, the following case is considered. A video feed receiver is located with the operator and is connected to a display device(s) which could be, but is not limited to, a computer, a video monitor, a tablet computer, a smart phone, a head mounted display, etc., and may be augmented with virtual cross-hairs, a target, etc. The operator uses the live video image to assist the capture process while controlling the invention. By keeping the target aircraft centered in the image or located on/within the cross-hairs during the approach and capture, the operator can be assured that the target aircraft will be captured centrally and optimally in the rear capture area 3. This is opposed to, and provides a significant advantage over the case where, a live video feed is provided by a camera that is not centrally located within the rear capture area 3. In this case, the operator must mentally adjust for parallax during the approach and capture phase. This suboptimal process may be difficult and can result in misses, partial captures, offset captures, and/or striking the target aircraft with the support vehicle 10. Therefore, the centrally located targeting camera 13 is advantageous.

In some embodiments, but not intended to be a limitation, the targeting camera and/or sensor 13 can provide data and imagery to an automated, or semi-automated interception, tracking and/or capture process. A computer program and associated hardware can utilize the data from the targeting camera and/or sensor 13 to control the support vehicle's 10 movements in order to automate or semi-automate the interception, tracking and/or capture process or assist the operator with a semi-autonomous or augmented interception, tracking and/or capture process.

In some embodiments, but not intended to be a limitation, the targeting camera 13 can be co-located or include distance measuring sensors, such as but not limited to, binocular vision, sonar, laser ranging, radar, etc. In some embodiments, this information is provided to the operator on a display to assist with distance to target or augmented data. In other embodiments, this information is provided to a computer process and associated hardware to assist with an autonomous, semi-autonomous or augmented interception, tracking and/or capture process.

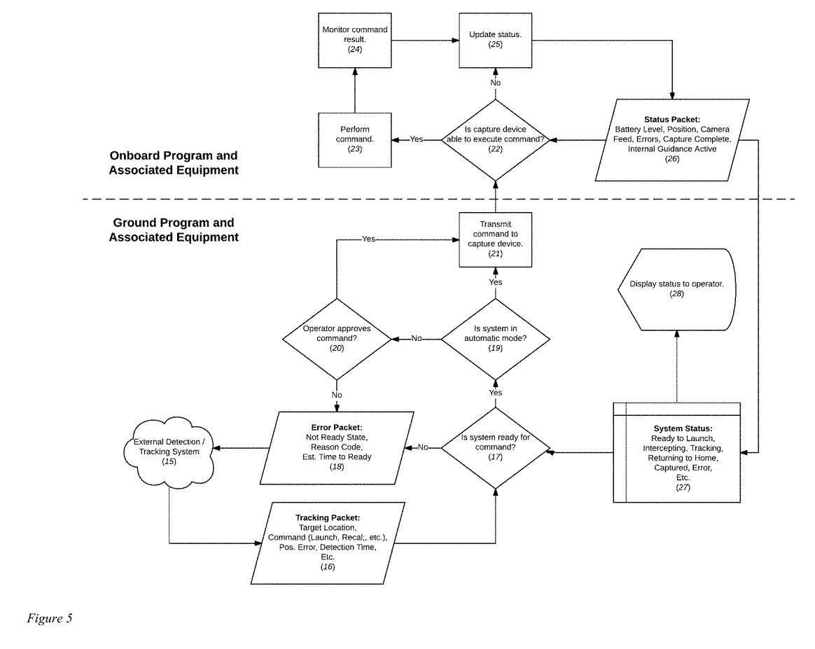

Referring to FIG. 5, another unique aspect of the invention, in some embodiments but not intended to be a limitation, is the ability to interface with external UAV detection and tracking systems. This ability provides the significant and unique advantage of, among other advantages, permitting the disruption device to accurately and effectively operate at a significant distance from the operator and/or base station and/or launch point thereby permitting beyond-visual-line-of-sight operations (“BVLOS”). This ability also provides the significant and unique advantage of, among other advantages, having the ability to utilize existing, planned or future UAV detection and tracking systems, whether those systems are known, unknown or yet to be invented. This ability also provides the significant and unique advantage of, among other advantages, pairing the disruption device with a detection and tracking system that is appropriate to the terrain and environment native to the disruption device's intended operating area.

For illustrative purposes, but not intended to be a limitation, the disruption device may be paired with a radar detection and tracking system for an urban environment and an auditory detection and tracking system for a forested environment. Furthermore, the detection and tracking system can be designed and/or built by a third-party and still be interoperable with the disruption device by utilizing the external detection and tracking interface unique to the invention's design. This provides the unique advantage of modularity to the invention's design allowing it to be interoperable with a wide range of systems.

As illustrated in FIG. 5, but not intending to be a limitation, the external detection/tracking system 15 detects a potential target UAV using methods and systems of its own design. It then communicates a collection of data to the invention using a tracking packet 16. The tracking packet may be communicated to the invention using hardware such as, but not limited to, a wired connection, serial connection, Ethernet network, Wi-Fi, fiber optics, etc., and may contain information such as, but not limited to, the target's location, threat's altitude, accuracy, time of detection, threat probability, errors, detection method, etc. The tracking packet 16 may also contain a command to instruct the invention to perform a specific, defined function such as, but not limited, launch, return to home, hover, pursue, capture, move to safe area, delay capture, loiter, destroy, land, emergency land, etc.

A program and associated hardware that is part of the invention, such as, but not intending to be a limitation, a computing device with attached storage and communication equipment, receives the tracking packet and determines if the system is ready to accept the command 17. The program and computing device refers to the system status 27 stored in memory or on an external storage device. The system status 27 is updated according to the status of the various components that makeup the inventions, including the disruption device status 26. For illustrative purposes, but not intending to be a limitation, the system status may contain information regarding the aircraft state, GPS and location data, battery status, hardware status, operator condition, signal strength, sensor status, flight time remaining, etc.

If the invention is not ready or cannot accept the command and/or tracking packet from the external detection/tracking system 15, the invention send an error packet 18 to the external detection and tracking system 15 indicating the type of error and potentially an estimated time to a ready state. The error packet 18 may contain information such as, but not limited to, battery error, GPS error, computing error, aircraft error, transmission error, malformed tracking packet, operator override, no error, unknown error, etc.

If the invention can accept the command and/or tracking packet from the external detection and tracking system 15 it then determines if the system is in automatic mode 19. This mode is set by the operator and stored by the invention in internal or external memory and tracked by a program and associated computing hardware. If the system is not in automatic mode 19, the operator is advised of the command and asked to approve it 20. For illustrative purposes, but not intended to be a limitation, the operator may perform this operation using a computer terminal, tablet computing device, smart phone computing device, laptop, desktop, etc. If the operator does not approve the command 20, an error packet 18 is sent to the external detection/tracking system 19 and the system resets the command loop.

If the operator does approve the command 20, or if the system is in automatic mode 19, the command is transmitted to the disruption device and associated hardware 21. For illustrative purposes, but not intended to be a limitation, the command may be transmitted using wireless data transmission hardware, wi-fi, wired transmission hardware, fiber optics, etc., and their associated programs.

The disruption device, along with associated hardware and programs, receives the command and determines if it is able to execute the command 22 in part by consulting the current device status 26. The device status 26 is stored in memory or on an external storage device. The device status 26 is updated according to the status of the various components that makeup the disruption device. For illustrative purposes, but not intending to be a limitation, the device status 26 may contain information regarding the aircraft state, GPS and location data, battery status, hardware status, operator condition, signal strength, sensor status, flight time remaining, etc. The device status 26 is communicated to the system status program 27 which may be run on another computing device, perhaps as part of a base station. The communication may be transmitted using wireless data transmission hardware, wi-fi, wired transmission hardware, fiber optics, etc.

Additionally, the current system status, which may include but is not limited to, sensor output, battery status, ready state, current command, mode, etc., is displayed to the operator 28. For illustrative purposes, but not intended to be a limitation, the status may be communicated to the operator 28 using a computer terminal, tablet computing device, smart phone computing device, laptop, desktop, etc.

If the disruption device is able to execute the command 22 it then executes the appropriate operation 23 for the command. For illustrative purposes, but not intended to be a limitation, this may be begin launch sequence, perform launch, move up, move down, turn right, turn left, increase speed, decrease speed, stop, hover, land, etc. The commands are performed using a combination of programs and onboard computing devices, potentially including but not limited to, a UAV autopilot system.

The disruption device then monitors the command result 24 to ensure it was properly executed. The command result 24 is used to update the disruption device's status 25. The disruption device status 25 is also updated if the disruption device was unable to execute the command 22. The updated status 25 is stored and distributed as a status packet 26. At this point the command loop and program structure repeats according to the design of the invention's systems, devices and associated methods. The system and associated methods also have provisions for the immediate takeover of the disruption device by an operator or automatic pilot if an error condition is sensed by any of the sensors, computing devices, hardware, software, systems, etc. or if the operator chooses to assume control of the device.

Referring to FIG. 5, but not intending to be a limitation, the hardware and programs are split into onboard and ground based. Onboard programs and equipment are contained on the disruption device and its associated support vehicle 10. The ground programs and equipment are contained on a base station. For illustrative purposes, but not intending to be a limitation, the base station may utilize a desktop computing device, laptop, tablet computing device, smart phone computing device, etc., and associated communication and transmission hardware and software.

While the present invention has been described above in terms of specific embodiments, it is hereby stated and understood that the invention is not limited to these disclosed embodiments. Many modifications and other embodiments of the invention may and will come to mind of those skilled in the art to which this invention pertains, and which are intended to be and are covered by both this disclosure and any appended claims. It is intended that the scope of the invention should be determined by proper interpretations and constructions of any appended claims and their legal equivalents, as understood by those of skill in the art relying upon the disclosure in this specification and the attached drawings.

1. An unmanned aerial vehicle capture apparatus comprising:
an unmanned aerial vehicle disruption area where the disruption area engages at least one unmanned aerial vehicle directly or at a distance;
a support aircraft for positioning said disruption area in order to inhibit a target unmanned aerial vehicle's ability to maintain flight;
an at least one onboard sensor in order to detect unmanned aerial vehicles in the vicinity of the support aircraft selected from at least one of the group radar, Lidar, sonar, an auditory sensor, a visual sensor, a light sensor, an infrared sensor, a heat sensor, a laser sensor, a radio frequency sensor, a pressure sensor, and a direct contact switch;
an onboard computer to receive and process data collected by an onboard sensor suite;
a flight control system onboard the support aircraft in order to stabilize the aircraft, gather telemetry data, respond to flight commands received from a command source selected from the group of an onboard computer, remote computer connected through a transmission device, a preprogrammed flight path, and an operator control station; and
an onboard camera to monitor the area surrounding the support aircraft.

2. The unmanned aerial vehicle capture apparatus of claim 1 further comprising:
an at least one capture sensor selected from at least one of the group of radar, Lidar, sonar, an auditory sensor, a visual sensor, a light sensor, an infrared sensor, a heat sensor, a laser sensor, a radio frequency sensor, a pressure sensor, and a direct contact switch;
a capture computer selected from at least one of the group of the onboard computer, the base station computer, a remote computer and an auxiliary computer to receive signals from the capture sensor in order to determine if a successful capture has been detected.

3. The apparatus of claim 1, where the disruption area is selected from at least one of the group of a net, a launched net, a mesh, chain, wire, fabric, plastic, metal, and wood, in order to engage and capture at least one unmanned aerial vehicle and disable its ability to maintain flight however preventing it from falling to the ground.

4. The apparatus of claim 1, where the disruption area is comprised of a device selected from the group of an explosive, a compressed air cannon, a battering ram, a projectile, an electric arc generator, a reinforced area, a chemical sprayer, a mechanical grinder, and a spike in order to impact the target unmanned aircraft and disable its ability to maintain flight with no regard to whether it falls to the ground.

5. The apparatus of claim 1, further comprising
a base station computer tracking the support aircraft's status, calculating and sending commands to the support aircraft, updating connected computers if any, receiving commands from an operator if present, and providing status information to an operator if present;
a data communication device providing communication between the base station computer device and the onboard computer through wireless engagement; and
an operator console providing system status and processing operator input.

6. The apparatus of claim 3, further comprising a lower shelf made from material as used for the disruption area, the shelf providing support to an at least one target unmanned aerial vehicle, and the shelf being located at the bottom of the disruption area to provide fall protection should the captured target improperly or incompletely engage in the disruption area.

7. The apparatus of claim 3, further comprising a side containment area made from material as used for the disruption area and attached to the disruption area on any side, the top, or any combination thereof, in order to contain the target unmanned aerial vehicle and to provide protection to the support aircraft should the target improperly or incompletely engage in the disruption area.

8. The apparatus of claim 1, wherein said disruption area is further comprised of a disabling mechanism selected from at least one of the group of an electric shock generator, a detonation device, a chemical sprayer, a laser, and a faraday cage in order to prevent a captured aerial vehicle from attempting to fly or release itself should the captured vehicle not engage fully in the disruption area.

9. The apparatus of claim 1, further comprising an at least one collateral damage mitigation material for materially reducing hazardous conditions potentially inflicted by the target unmanned aerial vehicle, devices contained thereon or items released from the target, where the at least one collateral damage mitigation material is selected from the group of explosive resistant material, projectile resistant material, chemical resistant material, biological resistant material, fire resistant material, heat resistant material, and entanglement material in order to protect the support aircraft as well as items, objects, property, vehicles and people in the vicinity.

10. The apparatus of claim 9, further comprising:
an at least one forward collateral damage mitigation material;
an at least one release mechanism selected from at least one of the group of an electric release, a pneumatic release, a hydraulic release, a magnetic release, and a mechanical release, to deploy the forward collateral damage mitigation material; and
a triggering system to activate the release mechanism.

11. The apparatus of claim 10 wherein the triggering system is commanded by the operator using the operator console and the transmission device between the console and the support aircraft.

12. The apparatus of claim 2 wherein the triggering system is commanded using the capture computer to release the forward mitigation material.

13. The apparatus of claim 10 wherein the triggering system is commanded using the capture computer to release the forward mitigation material.

14. A system for interfacing an unmanned aerial vehicle detection device and at least one unmanned aerial vehicle disruption device, comprising:
an external unmanned aerial vehicle detection and tracking system of design and operation separate from the unmanned aerial vehicle disruption device which is able to calculate a location, at least approximate, of potential target unmanned aerial vehicles;
an unmanned aerial vehicle disruption base station computer;
a computer data transmission media enabling communications between said external unmanned aerial vehicle detection and tracking device and said unmanned aerial vehicle disruption base station computer;
a defined data communications protocol transferring potential target unmanned aerial vehicle location and ancillary information between said detection computer and said unmanned aerial vehicle disruption base station computer;
an unmanned aerial vehicle disruption device;
an unmanned aerial vehicle disruption interface computer;
a wireless data transmitter and receiver pair enabling communications between said disruption base station and said unmanned aerial vehicle disruption aircraft device;
an unmanned aerial vehicle disruption aircraft flight control system;
an unmanned aerial vehicle disruption aircraft power source;
an operator computing device accepting operator input and calculating system information;
an operator display device displaying system information; and
an operator input device accepting operator input and commands through tactile, visual and/or auditory means.

15. The system of claim 14 wherein the data communications protocol is comprised of defined data fields selected from at least one of the group target location information, disruption device commands, ancillary information and status information, and when included, the disruption device command is selected from at least one of the group of launch, follow, capture, destroy, return to home, land, loiter, and ancillary commands, thereby facilitating the transfer of information from a multitude of potential unmanned aerial vehicle detection systems and the unmanned aerial vehicle disruption device.

16. The system of claim 15, where the unmanned aerial vehicle disruption base station computer receives and transmits data according to said data communications protocol, calculates system state, processes operator input, and calculates system response.

17. The system of claim 16 where the disruption device interface computer calculates command and status conditions selected from at least one of the group aircraft state, processes base station computer data transmissions, aircraft response, onboard sensor input, appropriate aircraft movement according to onboard sensors, desired response to sensor input, system health, and responses to emergency conditions.

18. The system of claim 14 further comprising a safety system which monitors an at least one status condition selected from the group of location, power state, operator input, proximity to structures, proximity to aircraft, proximity to terrain, signal strength, and ancillary conditions, and further comprises use of a programmed condition response table to calculate and command aircraft response to the detected condition.
